(19) United States
(12) Patent Application Publication
(10) Pub. No.: US 2022/0260773 A1
(43) Pub. Date: Aug. 18, 2022

(54) METHOD FOR MANUFACTURING LIGHT EMITTING DEVICE AND METHOD FOR MANUFACTURING LIGHT GUIDE PLATE

(71) Applicant: OMRON CORPORATION, Kyoto-shi, Kyoto (JP)

(72) Inventors: Hiroyuki ONITSUKA, Kyoto-shi (JP); Takahiro ONO, Kyoto-shi (JP); Junya FUJITA, Kyoto-shi (JP); Jun KISHIMOTO, Kyoto-shi (JP)

(73) Assignee: OMRON CORPORATION, Kyoto-shi, Kyoto (JP)

(21) Appl. No.: 17/629,799

(22) PCT Filed: Mar. 9, 2020
(86) PCT No.: PCT/JP2020/009977

§ 371 Date: Jan. 25, 2022

(30) Foreign Application Priority Data
Sep. 26, 2019 (JP) 2019-175950

(51) Int. Cl. F21V 8/00; G07F 17/32

(52) U.S. Cl. CPC G02B 6/0065; G07F 17/3211; G02B 6/0031; G02B 6/0078

(57) ABSTRACT

There are provided a method for manufacturing a light emitting device and a method for manufacturing a light guide plate, with which a light emitting device that is inexpensive and affords excellent space efficiency, despite having a plurality of light emitting surfaces with different angles, can be manufactured in a small number of steps and with stable quality. With this light emitting device, the end surface of one of the end portions that are butted together in a plurality of light guide plates is formed into an inclined surface having a reflection function for changing the angle at which the light is guided so that the light will be incident on the adjacent light guide plate. The light guide plate having the inclined surface with a reflection function is manufactured by cutting so as to obtain an inclined surface having a specific inclination angle when cutting out from a mother plate provided with a prism by nanoimprinting and to both sides of which are affixed laminates, after which the laminates on both sides are used as masks to form a reflective film on the end surface that was cut to an inclination angle.

### TECHNICAL FIELD

The present invention relates to a method for manufacturing a light emitting device featuring light guide plates, and to a method for manufacturing a light guide plate.

### BACKGROUND ART

Conventionally, there is known a technique in which light emitted from a light source unit is made to be incident on an end surface of a light guide plate, the light is reflected by a prism provided on the back surface of the light guide plate, and is emitted from the front surface of the light guide plate. A light emitting device featuring such a technique is installed in a game machine such as a slot machine located in a casino or the like. The applicant of the present application has also proposed in Patent Literature 1 a light emitting device that is favorably installed in a game machine.

Also, the present applicant has developed a light emitting device 100 comprising an elongated light guide plate as one of the light emitting devices as shown in FIG. 16. This light emitting device 100 is disposed on both sides of the front surface of a game machine, and emits light toward the front surface of the game machine, for example. FIG. 16 is an external view of this conventional light emitting device 100 installed on the right side of the game machine (the right side when facing the machine).

Here, the internal structure of the light emitting device 100 will be described with reference to FIG. 17. FIG. 17 is a cross-sectional view of the conventional light emitting device 100 that is cut in the lateral direction. As shown in FIG. 17, the light emitting device 100 comprises a light guide plate 101, a case 102, a cover 103, and an LED board 104. All of these members are formed in an elongated shape. The case 102 is disposed on the back surface side of the light guide plate 101 and supports the light guide plate 101. The LED board 104 has a plurality of LEDs 105 mounted in a row running along the lengthwise direction. The LEDs 105 are arranged so as to be opposite the end surface along the lengthwise direction of the light guide plate 101. The cover 103 is made of a transparent material and is disposed so as to cover the case 102, the light guide plate 101, and the LED board 104. A part of the cover 103 is painted black so that the LED board 104, the case 102, and the like are hard to see.

### CITATION LIST

### Patent Literature

Patent Literature 1: Japanese Laid-Open Patent Application “JP-A 2015-156317”

### SUMMARY

In the light emitting device 100, the front side of the game machine emits light, but the side surface side of the game machine emits light only at the end surfaces of a front light guide plate. Therefore, there are expectations for the development of a light emitting device that that emits light over a wider are on the side surface side so as to have more impact. If the side surface also emits light over a wider area, it can be seen from a wider angle.

However, as discussed above, a light guide plate can be bent if it has a large radius of curvature, but it cannot be bent at an angle such as 60 degrees or 90 degrees. Accordingly, in order for the side surface to emit light over as wide an area as the front surface, it is necessary for a separate light guide plate to be provided for the side surface. In this case, an LED board will be required for each of the front and side light guide plates, which reduces space efficiency of the unit. Also the cost will also of course increase.

In view of the above problem, it is an object of the present invention to provide a method for manufacturing a light emitting device, with which a light emitting device that is inexpensive and affords excellent space efficiency, despite having a plurality of light emitting surfaces with different angles, can be manufactured in a small number of steps and with stable quality, as well as a method for manufacturing a light guide plate.

### Solution to Problem

In order to solve the above problem, the method for manufacturing a light emitting device according to one mode of the present disclosure is a method for manufacturing a light emitting device comprising a light source unit and a plurality of light guide plates in which light that is incident from an end and is guided through the interior is reflected by a prism and is emitted from a light emitting surface, in which the plurality of light guide plates are disposed in a row in a state in which the angles of the light emitting surfaces differ between adjacent light guide plates, and the ends of adjacent light guide plates are butted against each other, the light source unit is disposed at the end of a starting end light guide plate that is at one end of the plurality of light guide plates, on the opposite side from the side where the adjacent light guide plates are butted against each other, and one of the end surfaces of the ends that are butted against each other in the plurality of light guide plates is formed as an inclined surface with a reflection function that changes the angle at which the light is guided and causes the light to be incident on the adjacent light guide plate, wherein the step of manufacturing a light guide plate whose end surface is formed as an inclined surface with a reflection function includes a cutting step of cutting so that a specific end surface becomes an inclined surface having a specific inclination angle between a first surface and a second surface when a light guide plate is cut out into a specific shape from a mother plate in which the first surface, on which a prism is provided by nanoimprinting, and the second surface, which becomes a light emitting surface on the opposite side from the first surface, are covered with a protective sheet, and a film formation step of using the protective sheet covering the first surface and the second surface as a mask to form a reflective film on the end surface having a specific inclination angle that was cut out in the cutting step.

### Effects

According to one aspect of the present disclosure, it is possible to provide a method for manufacturing a light emitting device that is inexpensive and affords excellent space efficiency, despite having a plurality of light emitting surfaces with different angles, in a small number of steps and with stable quality, as well as a method for manufacturing a light guide plate.

### BRIEF DESCRIPTION OF THE DRAWINGS

FIG. 1 is an oblique view showing the appearance of a game machine equipped with a decorative lighting device including the light emitting device according to the first embodiment of the present invention;

FIG. 2 is an oblique view showing the appearance of the decorative lighting device;

FIG. 3 is an exploded oblique view of the configuration of the right side portion of the light emitting device;

FIG. 4 is a cross-sectional view of the right side portion cut in the lateral direction, and includes a detail view;

FIG. 5 is a side view of the right side portion, including a detail view, and shows only a side light guide plate and an LED board;

FIG. 6 is a cross-sectional view showing how light is guided in the right side portion;

FIG. 7 is a schematic cross-sectional view showing in greater detail how light is guided in the right side portion;

FIG. 8 is a diagram showing the lit state and the unlit state of the side light guide plate and the front light guide plate in the right side portion;

FIG. 9 is a cross-sectional view of the right side portion of the light emitting device according to a second embodiment of the present invention, cut in the lateral direction, and includes a detail view;

FIG. 10 is a cross-sectional view showing how light is guided in the right side portion shown in FIG. 9;

FIG. 11 is a schematic cross-sectional view showing in greater detail how light is guided in the right side portion shown in FIG. 9;

FIG. 12 is a cross-sectional view showing how light is guided in the right side portion of the light emitting device according to a third embodiment of the present invention, including a detail view, and shows only a plurality of continuous light guide plates and an LED board;

FIG. 13 is a cross-sectional view of the light emitting device according to a fourth embodiment of the present invention, cut in the horizontal direction, and includes a detail view;

FIG. 14 is a diagram illustrating the step of providing a prism to a light guide plate by nanoimprinting according to Embodiment 5 of the present invention;

FIG. 15 is a diagram illustrating the step of cutting out a light guide plate and the step of forming a reflective film according to Embodiment 5 of the present invention, and includes a detail view,

FIG. 16 is an external view of a conventional light emitting device equipped with an elongated light guide plate installed on the right side of a game machine; and

FIG. 17 is a cross-sectional view of the conventional light emitting device shown in FIG. 16, cut in the lateral direction.

### DESCRIPTION OF EMBODIMENTS

An embodiment according to one aspect of the present disclosure (hereinafter also referred to as “this embodiment”) will now be described with reference to the drawings.

### § 1 APPLICATION EXAMPLE

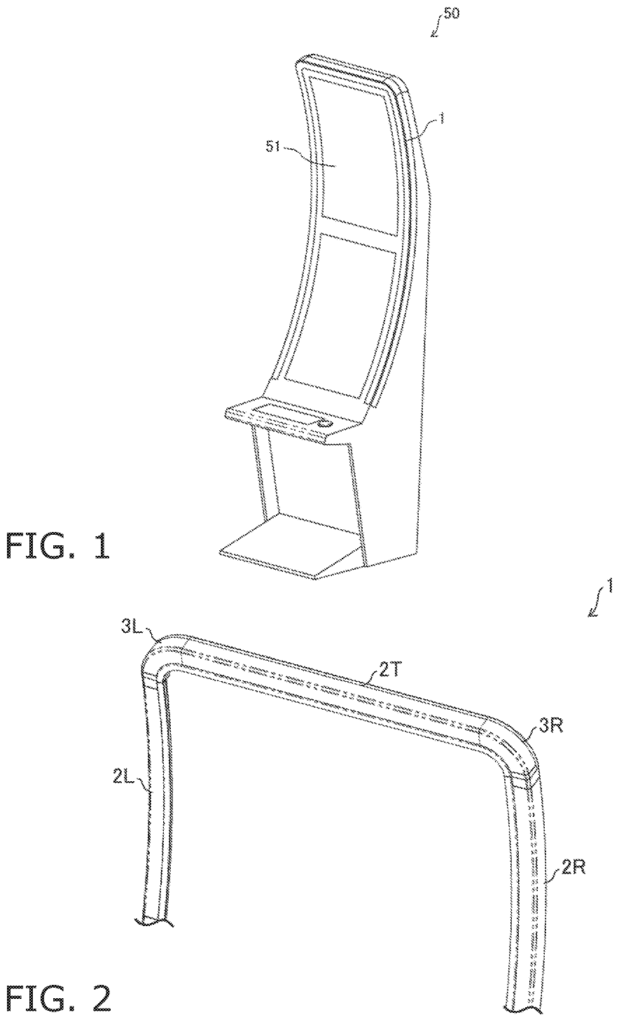

First, a manufactured light emitting device that is installed in a game machine 50 will be described as an example of a light emitting device with reference to FIGS. 1 to 4 and 6. As shown in FIG. 1, a decorative lighting device 1 (composed of a light emitting device) is attached to the edge on the front side of a housing 51 of the game machine 50, for example. As shown in FIG. 2, the decorative lighting device 1 is made up of three light emitting devices: a left side portion 2L, a right side portion 2R, and a top portion 2T.

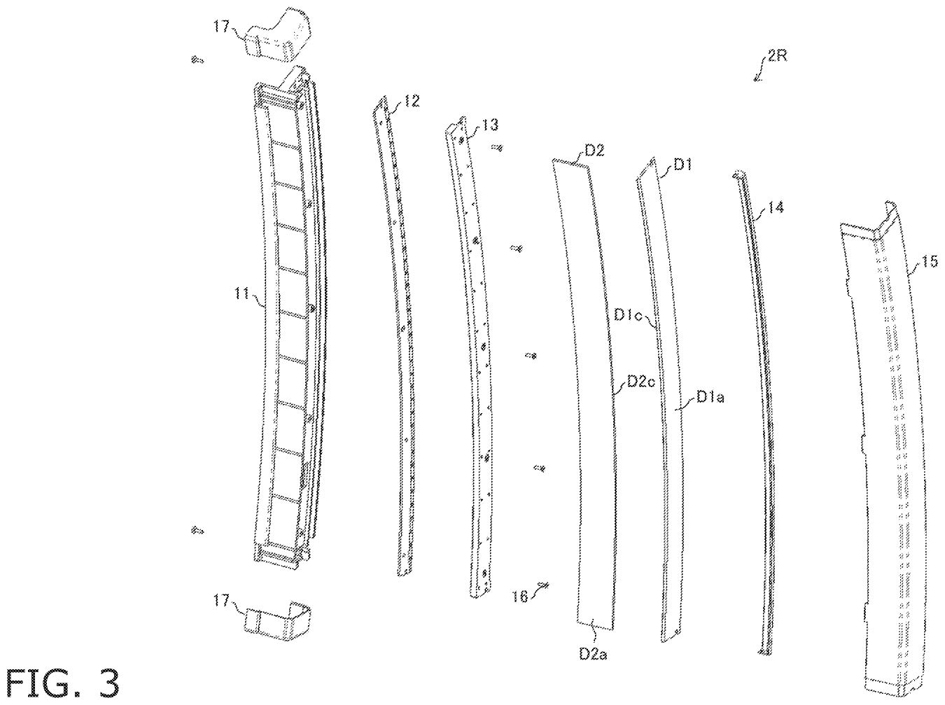

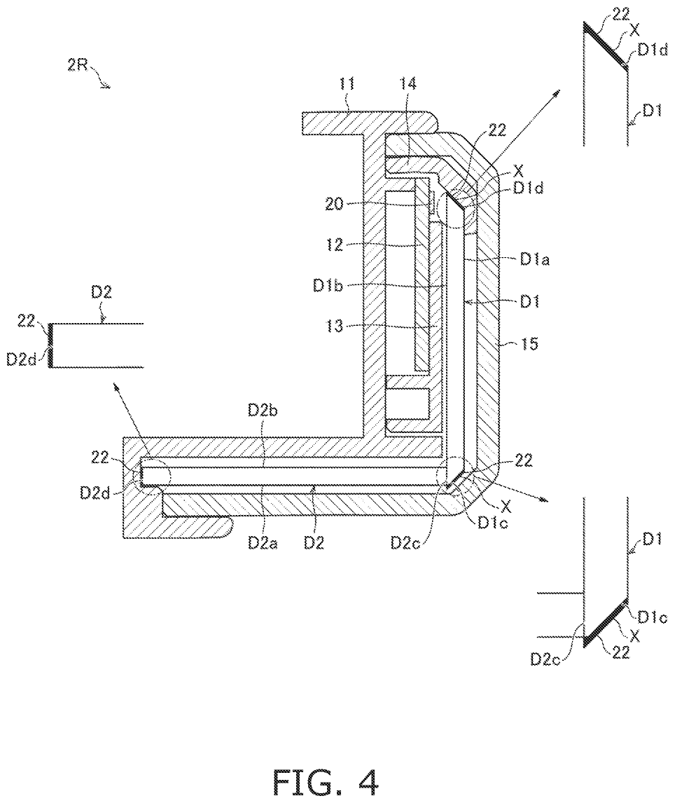

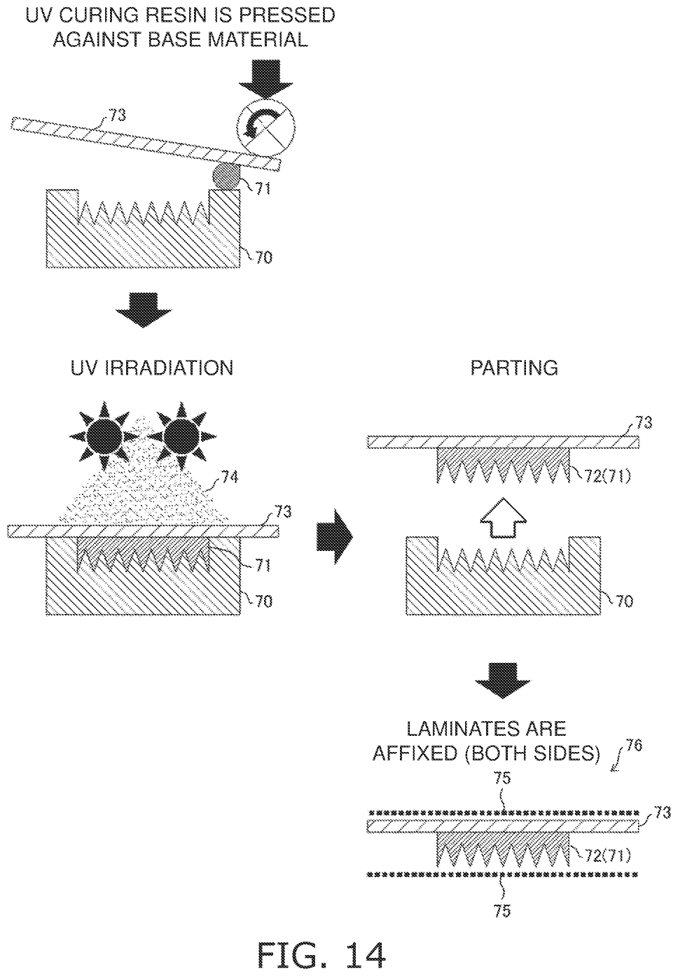

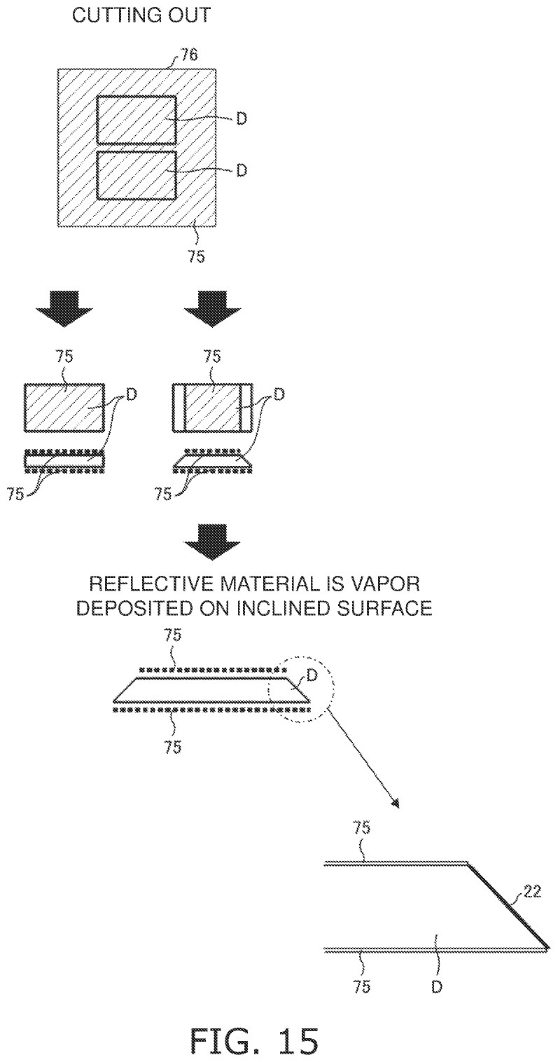

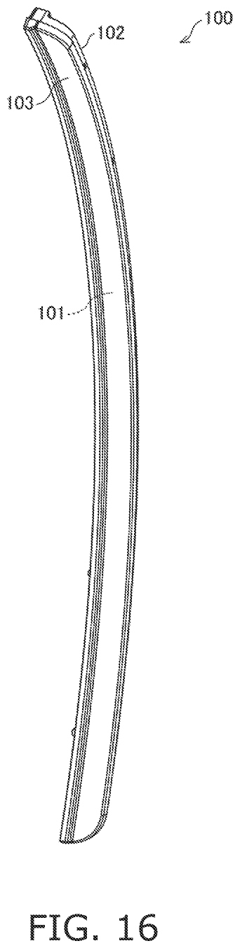

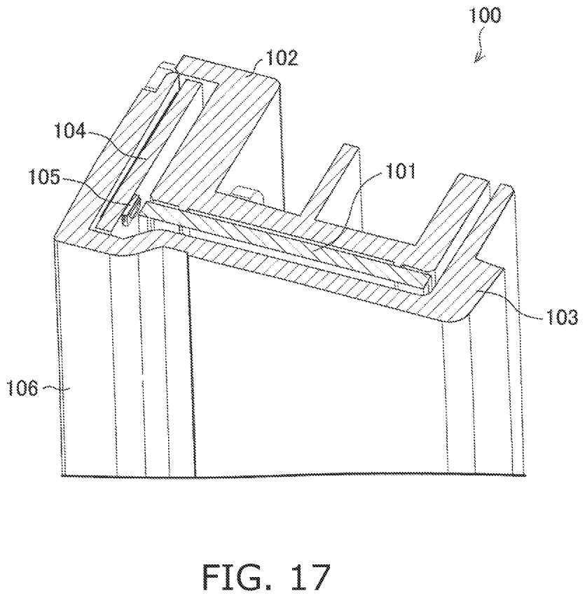

As shown in FIGS. 3 and 4, the right side portion 2R (a light emitting device) comprises a side light guide plate D1 and a front light guide plate D2 that are formed in an elongated shape, and an LED board 12 on which a plurality of LEDs 20 are mounted. The LED board 12 is disposed on the rear end side of the side light guide plate D1 and causes light to be incident on the side light guide plate D1 from the rear end side. In the side light guide plate D1 and the front light guide plate D2, D1a and D2a are light emitting surfaces that face the front side in a state of being attached to the game machine 50. A prism 72 (see FIG. 14) is formed on the opposite sides D1b and D2b from the light emitting surfaces D1a and D2a so that light that is guided through the inside is emitted from the light emitting surfaces D1a and D2a.

The side light guide plate D1 and the front light guide plate D2 are disposed side by side at an angle of 90 degrees with their ends abutted against each other. The end surface of one of the end portions abutting each other (here, the front end surface D1c of the side light guide plate D1) is formed as an inclined surface X with a reflection function. The inclined surface X with a reflection function has a function of guiding light through the inside of the side light guide plate D1 and causing the light that has reached the front end portion to be incident in the inside of the front light guide plate D2.

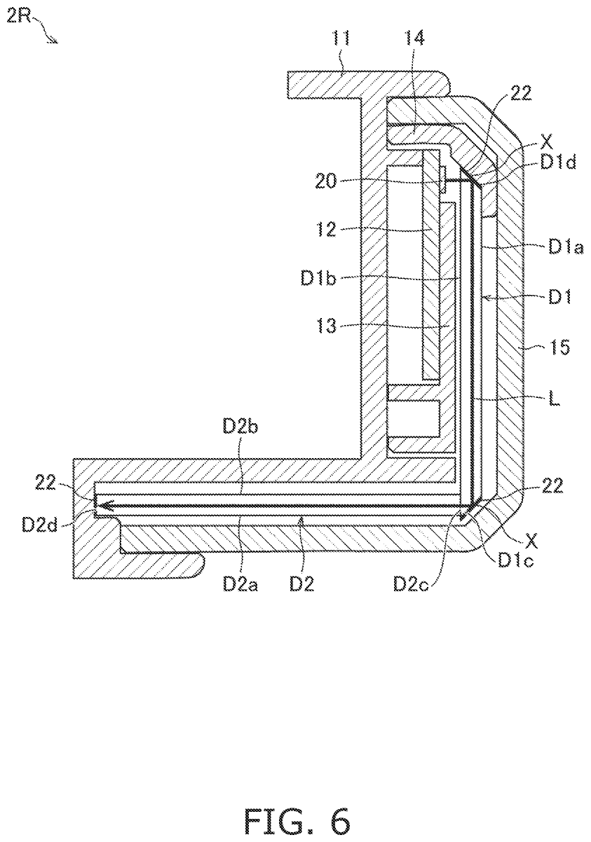

In the right side portion 2R configured as above, as shown in FIG. 6, the light from the LEDs 20 that is incident in the inside of the side light guide plate D1 from the rear end portion side proceeds to the front end while repeatedly undergoing specular reflection between the light emitting surface D1a and the opposite surface D1b. During this process, the light reflected by the prism 72 formed on the opposite surface D1b is emitted from the light emitting surface D1a. In FIG. 6, the light guide path L is indicated by a thick arrow.

The travel direction of the light that reaches the front end of the side light guide plate D1 is changed by 90 degrees at the inclined surface X with the reflection function of the front end surface D1c of the side light guide plate D1, and is incident on the front light guide plate D2 from the right end surface D2c of the right end of the front light guide plate D2. The light incident on the front light guide plate D2 travels through the inside of the front light guide plate D2, going from the right end to the left end. During this process, the light reflected by the prism 72 formed on the opposite surface D2b is emitted from the light emitting surface D2a.

Thus, in the right side portion 2R, the side light guide plate D1 and the front light guide plate D2 constituting the light emitting surfaces D1a and D2a with different angles can share the LED board 12 to be lit. Consequently, space efficiency as a unit is improved and the cost is lowered as compared with a conventional configuration in which an LED board 12 was required for each of the side light guide plate D1 and the front light guide plate D2 constituting the light emitting surfaces D1a and D2a with different angles. As a result, a light emitting device that has a plurality of light emitting surfaces with different angles, and that therefore has more impact, can be realized at a low cost and with excellent space efficiency.

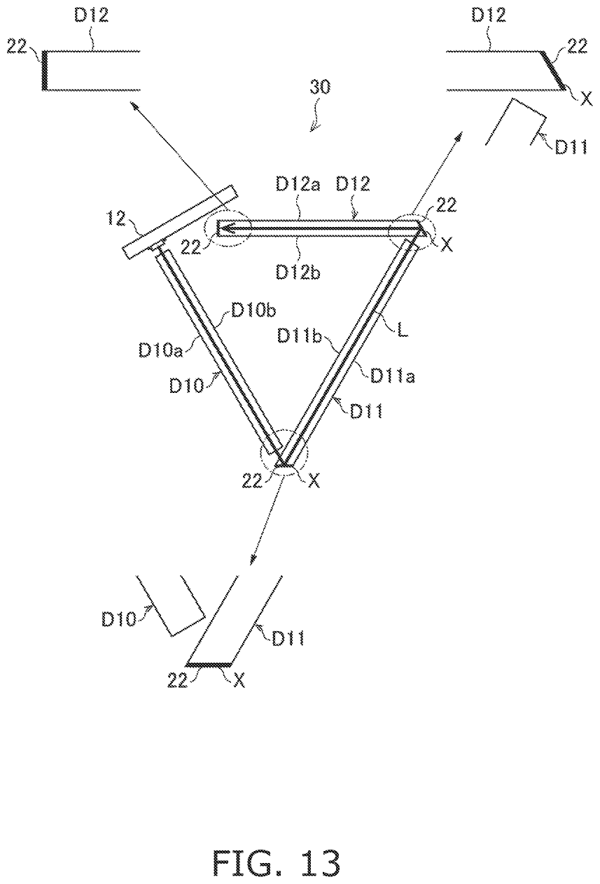

Also, a light emitting device that is installed in signage or the like, or the light emitting device 30 shown in FIG. 13 that is used as a lantern or other such lighting device, can also be manufactured.

As shown in FIG. 15, the above-mentioned light guide plate having the inclined surface X with a reflection function is made from a mother plate 76 in which a laminate 75 is affixed to the side on which a prism is provided by nanoimprinting and to the other side. When a light guide plate D is cut out from the mother plate 76 into a specific shape, the cutting is performed such that a specific end surface will become an inclined surface having a specific inclination angle. After this, the laminates 75 affixed to both sides are used as a mask to form a reflective film 22 on the end surface having a specific inclination angle.

Performing these steps allows a light guide plate having an inclined surface X with a reflection function to be manufacture in a small number of steps and stably. Because this method for manufacturing a light emitting device includes a step of manufacturing a light guide plate, a light emitting device that is inexpensive and affords excellent space efficiency, despite having a plurality of light emitting surfaces with different angles, can be manufactured in a small number of steps and with stable quality.

### § 2 CONFIGURATION EXAMPLE

### Embodiment 1

An embodiment of the present disclosure will now be described with reference to FIGS. 1 to 8. A light emitting device installed in the game machine 50 will be described as an example of the light emitting device in this embodiment.

1. Appearance of Game Machine

FIG. 1 is an oblique view of the game machine 50, in which is installed the decorative lighting device 1 including the light emitting device according to this embodiment. As shown in FIG. 1, the decorative lighting device 1 is attached to the edge on the front side of the housing 51 of the game machine 50. In the example in FIG. 1, the decorative lighting device 1 has an inverted U shape when viewed from the front, and is attached to three sides: the left and right sides on the front side of the housing 51 and the top side. A recess for fitting the decorative lighting device 1 is provided on the front edge of the housing 51, and the decorative lighting device 1 is attached to this recess. In this Specification, the left-right direction is the left-right direction when looking at the front of the game machine 50.

2. Appearance of Decorative Lighting Device

FIG. 2 is an oblique view of the appearance of the decorative lighting device 1. As shown in FIG. 2, the decorative lighting device 1 comprises three light emitting devices: a left side portion 2L, a right side portion 2R, and a top portion 2T. The upper end of the left side portion 2L and the left end of the top portion 2T are connected at the lower end of the left corner portion 3L, and the upper end of the right side portion 2R and the right end of the top portion 2T are connected at the lower end of the right corner portion 3R. The left side portion 2L and the right side portion 2R have a length of about 120 cm, for example, and have a warp that bends toward the front side going downward. The left side portion 2L and the right side portion 2R have a structure that is in left and right symmetry. The top portion 2T has a length corresponding to the width of the game machine 50, and is formed in an inverted U shape that includes the left corner portion 3L and the right corner portion 3R. The left side portion 2L, the right side portion 2R, and the top portion 2T differ in length, whether or not there is warpage, and orientation, but are all configured as a light emitting device. The right side portion 2R will now be described in detail.

3. Configuration of Right Side Portion 2R

FIG. 3 is an exploded oblique view of the configuration of the right side portion 2R. FIG. 4 is a cross-sectional view of the right side portion 2R, cut in the lateral direction, and includes a detail view. As shown in FIGS. 3 and 4, the right side portion 2R comprises a case 11, an LED board (light source portion) 12, a board cover 13, a side light guide plate (starting end light guide plate, first light guide plate) D1, a front light guide plate (final end light guide plate, second light guide plate) D2, an inner cover 14, and an outer cover 15. All of these members are formed in an elongated shape.

The side light guide plate D1 and the front light guide plate D2 are both plate-shaped members having a thickness of about 2 mm and made of transparent polycarbonate, acrylic resin, or the like. In the side light guide plate D1 and the front light guide plate D2, the light that is incident from the end and is guided through the inside is reflected by a prism 72 (see FIG. 14) described later, and is emitted from the light emitting surfaces (second surface) D1a and D2a. The prism is formed on the opposite surfaces (first surface) D1b and D2b from the light emitting surfaces D1a and D2a.

As shown in FIGS. 3 and 4, the case 11 has a T-shaped cross section cut in the lateral direction, and has a warp that bends downward toward the front side of the game machine 50. The front light guide plate D2 is attached to the front-facing surface of the case 11. The front light guide plate D2 is attached with the light emitting surface D2a facing the front. Attaching the case 11 having a warp means that the front light guide plate D2 will also have a warp so as to bend downward toward the front side, and the light emitting surface D2a is a curved surface.

The LED board 12, the board cover 13, and the side light guide plate D1 are disposed in that order on the surface of the case 11 facing the right side of the game machine 50. The board cover 13 has a function of hiding the LED board 12 so that it cannot be seen from the outside, and is fixed to the case 11 together with the LED board 12 with a plurality of screws 16.

A plurality of LEDs 20 (light sources) are mounted on the LED board 12 in a row along the lengthwise direction. The LEDs 20 are located at the rear end of the LED board 12, and the LEDs 20 are opposite the rear end of the opposite surface D1b of the side light guide plate D1. The light source is preferably one that has directivity such as the LEDs 20, but the light source is not limited to the LEDs 20.

The side light guide plate D1 is disposed with the light emitting surface D1a facing the right side. As will be described in detail below, the right end portion having the right end surface D2c running in the lengthwise direction of the front light guide plate D2 disposed in the left-right direction, and the front end portion having the front end surface D1c running in the lengthwise direction of the side light guide plate D1 disposed in the front-rear direction are butted together at a 90 degree angle. The side light guide plate D1 and the front light guide plate D2 are disposed side by side with their ends butted together. When the LED board 12 (light source unit) is shared by a plurality of light guide plates, the light is attenuated moving downstream in the direction in which the light travels, but with a configuration in which the light guide plates have an elongated shape and the ends running in the lengthwise direction are butted together, it is possible to suppress this attenuation of light so that a plurality of light emitting surfaces effectively emit light.

The side light guide plate D1 and the front light guide plate D2 correspond to a plurality of light guide plates that are side by side in a state in which the angles of the light emitting surfaces are different between the adjacent light guide plates and the ends of adjacent light guide plates are butted together. In this embodiment, a configuration is described in which there are two light guide plates, namely, the side light guide plate D1 and the front light guide plate D2, but a configuration comprising three or more light guide plates is also possible, which will be described below.

The inner cover 14 is disposed so as to cover the rear end portion of the LED board 12 and the side light guide plate D1. The inner cover 14 has a function of hiding the LEDs 20 mounted on the LED board 12 so that the LEDs 20 are not directly visible from the outside.

The outer cover 15 is a protective cover made of a transparent material, and is positioned so as to cover the light emitting surfaces D1a and D2a of the side light guide plate D1 and the front light guide plate D2 from the outside. In the drawings, the member numbered 17 is an end cover that protects the vertical end portion of the right side portion 2R.

4. Side Light Guide Plate D1, Front Light Guide Plate D2

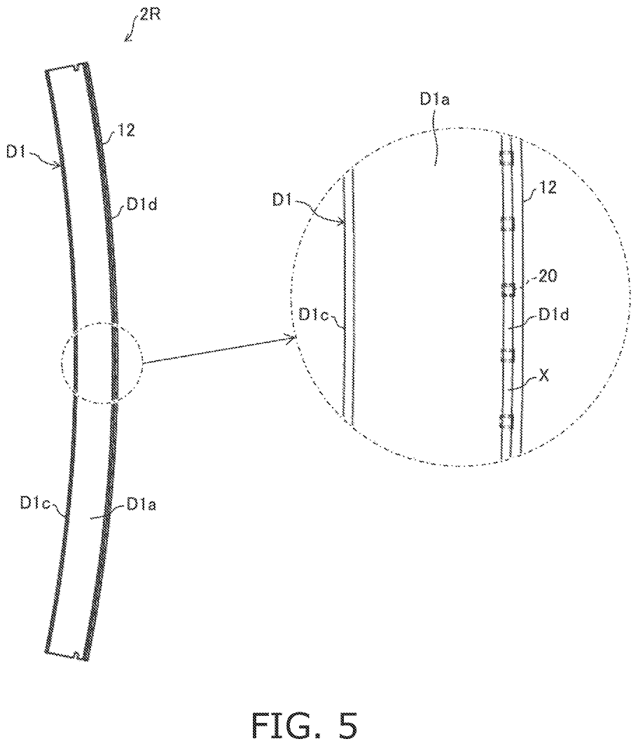

The side light guide plate D1 and the front light guide plate D2 will be described with reference to FIGS. 3 to 5. FIG. 5 is a side view of the right side portion 2R, including a detail view, and shows only the side light guide plate D1 and the LED board 12.

As shown in FIG. 3, the case 11 has a warp, and when attached to this case 11, the front light guide plate D2 that is disposed on the front side also takes on a warp that bends out to the front side going downward, with the light emitting surface D2a becoming a curved surface. Then, as shown in FIG. 4, the side light guide plate D1 that is disposed on the side surface side is disposed in a state in which the front end portion having the front end surface D1c is butted against the right end portion having the right end surface D2c of the front light guide plate D2.

As shown in FIG. 5, the front end portion of the front end surface D1c that is butted against the front light guide plate D2 in the side light guide plate D1 has a shape corresponding to the warp of the front light guide plate D2, which is what makes it possible to butt the two together.

Also, as shown in FIG. 5, the LEDs 20 mounted on the LED board 12 are disposed facing the opposite surface D1b of the side light guide plate D1, on the rear end side of the rear end surface D1d of the side light guide plate D1.

In order to change the angle of the LED light incident from the opposite surface D1b and to guide the light toward the front end portion of the side light guide plate D1, the rear end surface D1d of the side light guide plate D1 is formed as an inclined surface X with a reflection function. This inclined surface X with a reflection function has the function of changing the angle at which the light is guided, and subjects the light to specular reflection.

As shown in FIG. 4, the rear end surface D1d of the side light guide plate D1 is an inclined surface that is inclined at an angle of 45 degrees from the opposite surface D1b toward the light emitting surface D1a. Providing the reflective film 22 to the inclined surface forms the inclined surface X with a reflection function. The reflective film 22 can be formed from a reflective material such as aluminum by vapor deposition or another such manufacturing method. Setting the angle of the inclined surface to 45 degrees allows the travel direction of the light of the LEDs 20 incident from the opposite surface D1b to be changed by 90 degrees. Providing the reflective film 22 makes it possible to effectively suppress the attenuation of light.

As shown in FIG. 4, the inclined surface X with a reflection function is also formed on the front end surface D1c of the front end portion of the side light guide plate D1, which is butted against the right end portion of the front light guide plate D2. The front end surface D1c of the side light guide plate D1 is also an inclined surface that is inclined at an angle of 45 degrees from the opposite surface D1b toward the light emitting surface D1a, and the reflective film 22 is formed on this inclined surface. The inclined surface X with a reflection function formed on the front end surface D1c of the side light guide plate D1 has the function of guiding light through the inside of the side light guide plate D1 and making the light of the LEDs 20 that has reached the front end portion of the side light guide plate D1 be incident inside the front light guide plate D2.

Also, in this embodiment, as a preferred configuration, the reflective film 22 is also formed on the left end surface D2d of the front light guide plate D2. The reflective film 22 formed on the left end surface D2d has the function of turning back the light that has reached the left end surface D2d.

5. Guiding Light in Right Side Portion 2R

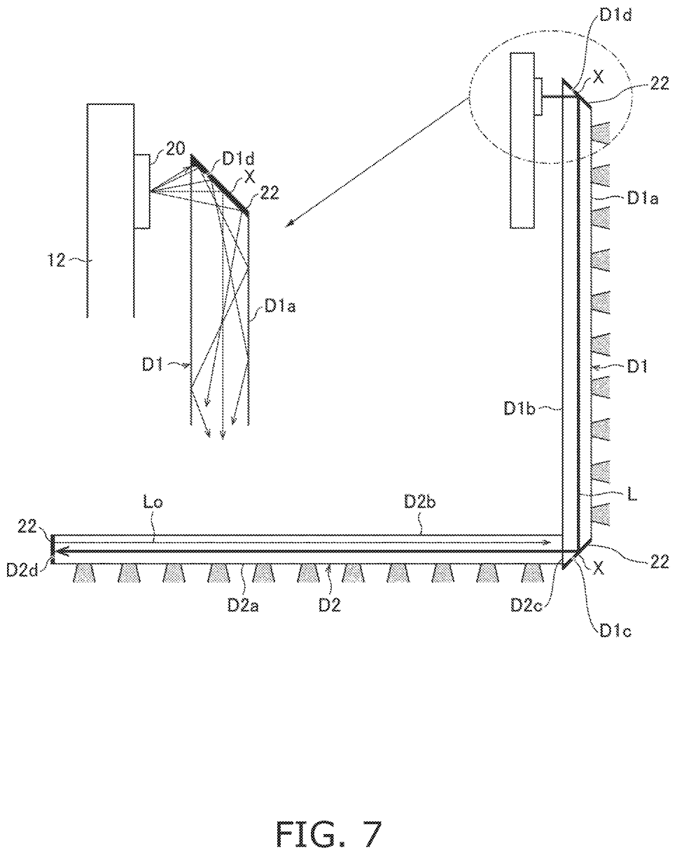

The guiding of light in the right side portion 2R will be described with reference to FIGS. 6 and 7. FIG. 6 is a cross-sectional view showing how light is guided in the right side portion 2R. FIG. 7 is a schematic cross-sectional view showing in greater detail how light is guided in the right side portion 2R. In FIGS. 6 and 7, the light guide path L of the light from the LEDs 20 is indicated by the thick arrow.

As shown in FIG. 6, the light emitted from the LEDs 20 is incident from the opposite surface D1b of the side light guide plate D1, the travel direction of the light is changed by 90 degrees at the inclined surface X with the reflection function of the rear end surface D1d, and the light is guided from the rear end portion to the front end portion through the inside of the side light guide plate D1. The travel direction of the light that has reached the front end portion of the side light guide plate D1 is changed by 90 degrees at the inclined surface X with the reflection function of the front end surface D1c of the side light guide plate D1, and is incident on the front light guide plate D2 from the right end surface D2c of the right end portion of the front light guide plate D2. The light incident on the front light guide plate D2 is guided through the inside of the front light guide plate D2, from the right end portion to the left end portion. The light that has reached the left end portion of the front light guide plate D2 is turned back by the reflective film 22 formed on the left end surface D2d.

As shown in FIG. 7, the light of the LEDs 20 is undergoes specular reflection at the inclined surface X with a reflection function on the opposite surface D1b of the side light guide plate D1. The light that has undergone specular reflection at the inclined surface X with a reflection function proceeds through the inside of the side light guide plate D1 to the front end portion while repeatedly undergoing specular reflection between the light emitting surface D1a and the opposite surface D1b. During this process, the light incident on the prism 72 formed on the opposite surface D1b is reflected by the prism 72, and is emitted from the light emitting surface D1a, where it can be seen. The same applies to the inside of the front light guide plate D2, and the light made incident on the inside of the front light guide plate D2 at the inclined surface X with the reflection function of the front end surface D1c of the side light guide plate D1 proceeds to the left end portion while repeatedly undergoing specular reflection between the light emitting surface D2a and the opposite surface D2b. During this process, the light incident on the prism 72 formed on the opposite surface D2b is reflected by the prism 72, and is emitted from the light emitting surface D2a, where it can be seen. The thin arrow indicated by LO in FIG. 7 is light that has been turned back by the reflective film 22 of the left end surface D2d of the front light guide plate D2. Turning back the light that has reached the end point allows the light of the LEDs 20 to be used more effectively, which affords brighter illumination.

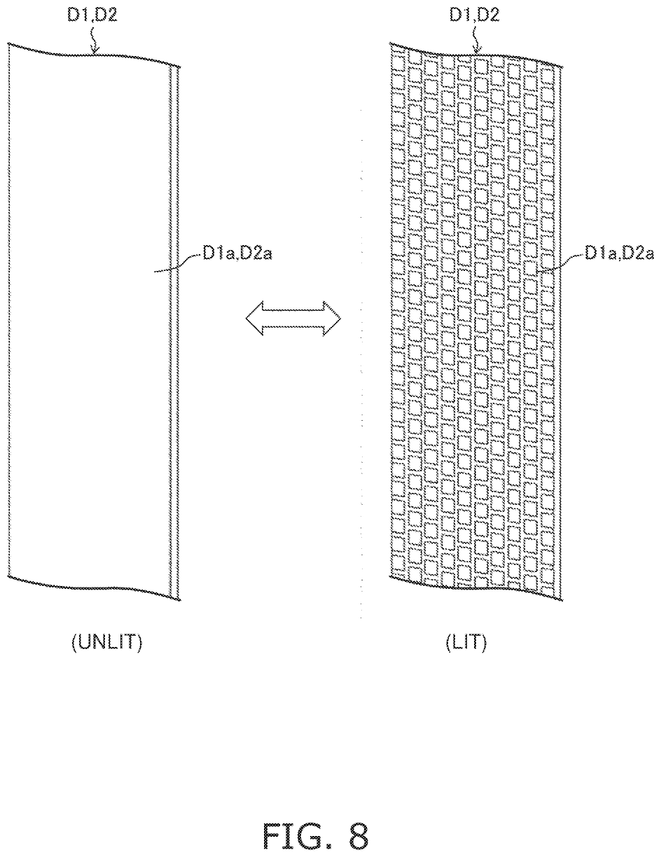

FIG. 8 is a diagram showing the lit and unlit states of the side light guide plate D1 and the front light guide plate D2. When the LEDs 20 are lit, the design or graphics drawn by the prism 72 emerge.

6. Effect

With the above configuration, the side light guide plate D1 and the front light guide plate D2 are disposed side by side at an angle of 90 degrees with the ends butted together, and the end surface of one of the end portions butted together (here, the front end surface D1c) is formed as an inclined surface X with a reflection function. Consequently, the light guided by the side light guide plate D1 is made incident on the front light guide plate D2 at the inclined surface X with the reflection function.

As a result, the side light guide plate D1 and the front light guide plate D2 constituting the light emitting surfaces D1a and D2a with different angles share the LED board 12 for illumination. Compared to a conventional configuration in which an LED board 12 was required for each of the side light guide plate D1 and the front light guide plate D2 constituting the light emitting surfaces D1a and D2a with different angles, the space efficiency as a unit is improved. Also, since the number of LED boards 12 can be reduced, the cost can also be lower.

Also, with the above configuration, when the end surface of either the side light guide plate D1 or the front light guide plate D2 is used as the inclined surface X with the reflection function, the side light guide plate D1 side having the inclined surface X with the reflection function is also selected for the rear end surface D1d. Therefore, the front light guide plate D2 does not need an inclined end surface, and may be an end surface forming a right angle to the light emitting surface D2a, as in a conventional case. Thus manufacturing the light guide plate provided with the inclined surface X with the reflection function separately from the light guide plate not provided with the inclined surface X having the reflection function reduces manufacturing costs.

### Embodiment 2

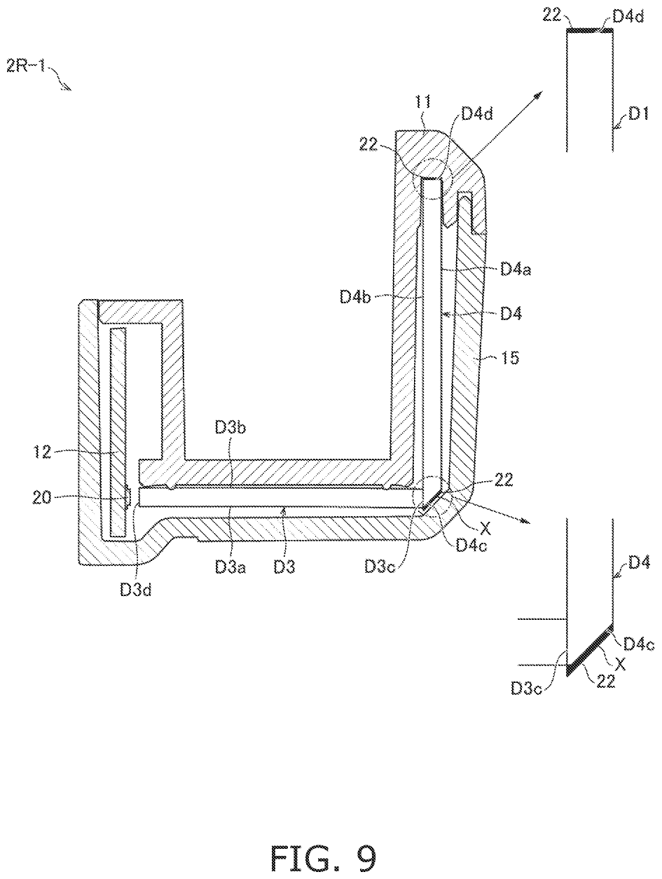

Another embodiment of the present invention will now be described with reference to FIGS. 9 to 11. For the sake of description, those members having the same functions as in the first embodiment are numbered the same, and will not be described again.

A light emitting device installed in the game machine 50 will again be described as an example of the light emitting device in this embodiment. In the right side portion 2R having the configuration of the light emitting device of Embodiment 1, the LED board 12 is disposed on the opposite surface D1b on the rear end portion side of the side light guide plate D1. Accordingly, an inclined surface X with a reflection function has to be provided to the rear end surface D1d of the side light guide plate DE With this configuration, the inclined surface X with a reflection function is necessary for the rear end surface D1d of the side light guide plate D1, but it is much less likely that the LEDs 20 will be visible directly from the outside.

On the other hand, with a right side portion 2R-1 having the configuration of the light emitting device of this embodiment, as shown in FIG. 9, the LED board 12 is disposed on the left side of the front light guide plate D3 (starting end light guide plate, first light guide plate), so that light is incident from the left end surface D3d of the front light guide plate D3. FIG. 9 is a cross-sectional view of the right side portion 2R-1 having the configuration of the light emitting device of this embodiment, cut in the lateral direction, and includes a detail view. The appearance of the right side portion 2R-1 is approximately the same as that of the right side portion 2R.

With this configuration, the inclined surface X with a reflection function is only at one place, where the ends of the front light guide plate D3 and the side light guide plate (final end light guide plate, second light guide plate) D4 are butted together, so there is a reduction in the loss of light due to reflection on the inclined surface X with the reflection function. Also, since the LED board 12 is located on the attachment side when the decorative lighting device 1 (see FIG. 1) is attached to the game machine 50, there is no need for the board cover 13 or the inner cover 14, and the number of parts can be reduced.

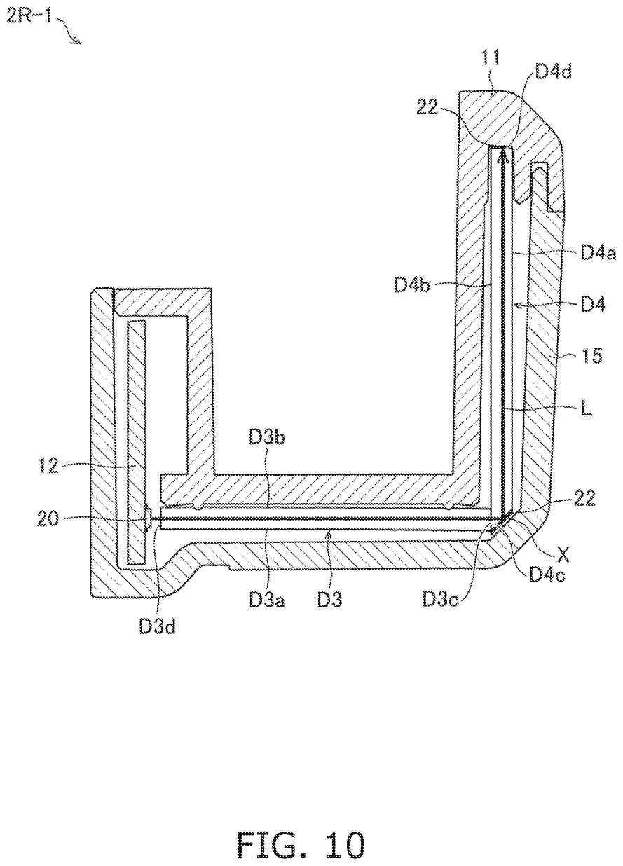

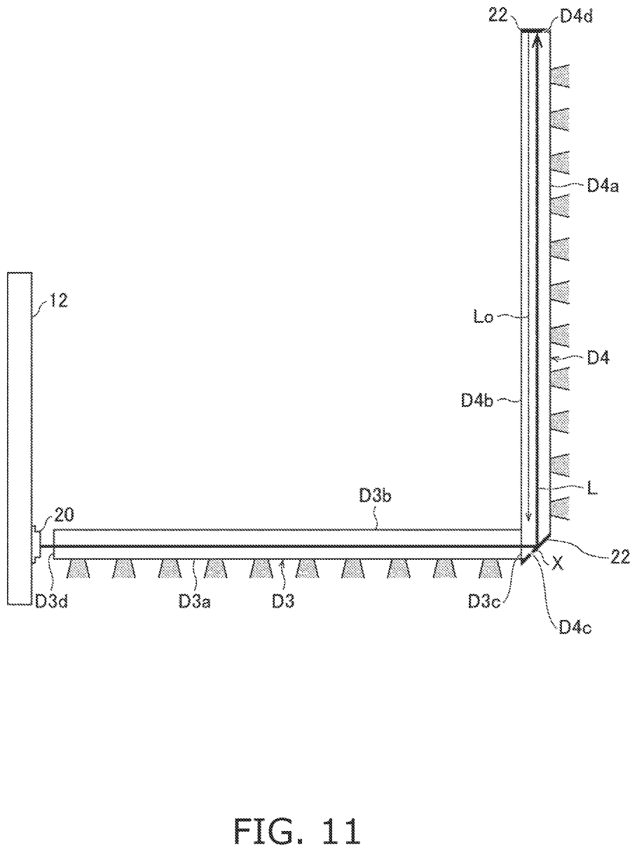

The light guidance in the right side portion 2R-1 will be described with reference to FIGS. 10 and 11. FIG. 10 is a cross-sectional view showing how light is guided in the right side portion 2R-1. FIG. 11 is a schematic cross-sectional view showing in greater detail how light is guided in the right side portion 2R-1. In FIGS. 10 and 11, the light guide path L of the light from the LEDs 20 is indicated by a thick arrow.

As shown in FIG. 10, the light emitted from the LEDs 20 is incident on the left end surface D3d of the front light guide plate D3, and is guided through the inside of the side light guide plate D1, from the left end portion to the right end portion. The travel direction of the light that has reached the right end portion of the front light guide plate D3 is changed by 90 degrees at the inclined surface X with the reflection function of the front end surface D4c of the side light guide plate D4, and the light is guided through the inside of the side light guide plate D4, from the front end portion to the rear end portion. The light that has reached the rear end portion of the light guide plate D4 is turned back by the reflective film 22 formed on the rear end surface D4d.

As shown in FIG. 11, the light incident from the left end surface D3d of the front light guide plate D3 proceeds through the inside of the front light guide plate D3 to the right end portion while repeatedly undergoing specular reflection between the light emitting surface D3a and the opposite surface D3b. During this process, the light incident on the prism 72 formed on the opposite surface D3b is reflected by the prism 72, is emitted from the light emitting surface D3a, and can be seen. The same applies to the inside of the side light guide plate D4, and the light made incident on the inside of the side light guide plate D4 at the inclined surface X with the reflection function of the front end surface D4c of the side light guide plate D4 proceeds to the rear end portion while repeatedly undergoing specular reflection between the light emitting surface D4a and the opposite surface D4b. During this process, the light incident on the prism 72 formed on the opposite surface D4b is reflected by the prism 72, is emitted from the light emitting surface D4a, and can be seen.

### Embodiment 3

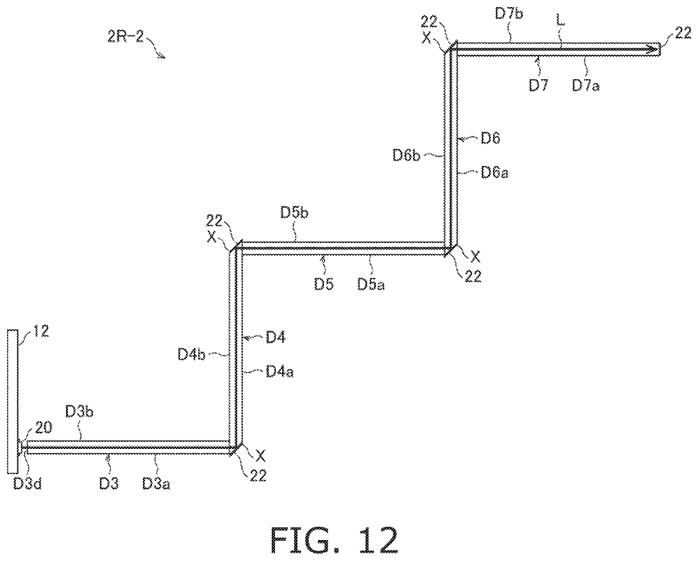

Another embodiment of the present invention will now be described with reference to FIG. 12. For the sake of description, those members having the same functions as in Embodiments 1 and 2 are numbered the same, and will not be described again.

Again in this embodiment, a light emitting device installed in the game machine 50 will be described as an example of a light emitting device. With the right side portion 2R-1 having the configuration of the light emitting device of Embodiment 2, the front light guide plate D3 and the side light guide plate D4 were provided, and the end surface of one of the portions where the ends are butted together is formed as an inclined surface X with a reflection function.

By contrast, as shown in FIG. 12, the right side portion 2R-2 having the configuration of the light emitting device of this embodiment is configured to comprise a front light guide plate D5, a side light guide plate D6, and a front light guide plate D7 behind the side light guide plate D4. FIG. 12 is a cross-sectional view showing how light is guided in the right side portion 2R-2, includes a detail view, and shows only a plurality of light guide plates D3 to D7 and an LED board 12 which are connected to together.

The ends of the light guide plates D3 to D7 are butted against each other so as to form an angle of 90 degrees between adjacent light guide plates. The end surface of one of the end portions where the side light guide plate D4 and the front light guide plate D5 are butted together is formed as the inclined surface X with a reflection function. In the example in FIG. 12, the end surface of the side light guide plate D4 is formed as the inclined surface X with a reflection function. Similarly, the end surface of one of the end portions where the front light guide plate D5 and the side light guide plate D6 are butted together is formed as the inclined surface X with a reflection function. Similarly, the end surface of one of the end portions where the side light guide plate D6 and the front light guide plate D7 are butted together is formed as the inclined surface X with a reflection function. In the example in FIG. 12, the front and rear end surfaces of the side light guide plate D6 are both formed as the inclined surface X with a reflection function. Also, as a preferred configuration, a reflective film 22 is provided to the right end surface of the front light guide plate D7 (final end light guide plate) located at the final end of the plurality of light guide plates D3 to D7.

With this configuration, as five light emitting surfaces (D3a to D7a) can share the LED board 12 for illumination, which affords decorative lighting with even more impact. Although a configuration comprising five light guide plates was given as an example here, the number of light guide plates is not limited to this.

### Embodiment 4

Another embodiment of the present invention will now be described with reference to FIG. 13. For the sake of description, those members having the same functions as in Embodiments 1 to 3 are numbered the same, and will not be described again.

In this embodiment, a light emitting device 30 that can be used as an illumination device, such as a lantern, will be described as an example of a light emitting device. FIG. 13 is a cross-sectional view of the light emitting device 30 according to this embodiment, cut in the horizontal direction, and includes a detail view. As shown in FIG. 13, the light emitting device 30 comprises a light guide plate D10, a light guide plate D11, and a light guide plate D12. No external view is not shown, but since this is a lighting fixture such as a lantern, the three light guide plates D10 to D12 do not have to have an elongated shape.

The ends of the three light guide plates D10 to D12 are butted together so as to form an angle of 60 degrees between adjacent light guide plates. The three light guide plates D10 to D12 are disposed with the opposite surfaces D10b to D12b, on which prisms 72 are formed, facing inward and the light emitting surfaces D10a to D12a facing outward. The end surface of one of the end portions where the light guide plate D10 and the light guide plate D11 are butted together is formed as the inclined surface X with a reflection function. In the example in FIG. 13, the end surface of the light guide plate D11 is formed as the inclined surface X with a reflection function. Similarly, the end surface of one of the end portions where the light guide plate D11 and the light guide plate D12 are butted together is formed as the inclined surface X with a reflection function. In the example in FIG. 13, the end surface of the light guide plate D12 is formed as the inclined surface X with a reflection function.

Here, the inclination angle of the inclined surface X with the reflection function is set so that the that is emitted from the end surfaces of the light guide plates D10 and D12 and is incident on the opposite surfaces D11b and D12b of the light guide plates D11 and D12 will be guided to the end portion on the opposite side from the incident side of the light guide plates D11 and D12.

The LED board 12 serving as a light source portion is disposed at the end portion on the opposite side from the side of the light guide plate (starting end light guide plate) D10 that is butted together with the light guide plate D11. Also, as a preferred configuration, the reflective film 22 is provided on the end surface of the light guide plate D12 (final end light guide plate) located at the final end of the three continuous light guide plates D10 to D12, on the opposite side from the side butted together with the light guide plate D11.

With this configuration, it is possible to realize a lantern or other such lighting fixture that is inexpensive and offers excellent space efficiency. A configuration comprising three light guide plates was given as an example here, but the number of light guide plates is not limited to this.

### Embodiment 5

Another embodiment of the present invention will now be described with reference to FIGS. 14 and 15. For the sake of description, those members having the same functions as in Embodiments 1 to 4 are numbered the same, and will not be described again.

The elongated front or side light guide plates D1 to D7, which have a length of about 120 cm, described in the Embodiments 1 to 3 are difficult to manufacture by pouring a transparent material into a mold in which an inverted pattern of the prism 72 has been formed on the bottom surface. Therefore, these plates are manufactured by providing the prism 72 by nanoimprinting on the mother plate of a light guide plate having both surfaces formed flat, and then cutting the prism 72 into a specific shape.

Also, the light guide plate D11 and the light guide plate D12 described in Embodiment 4 can be manufactured by using an injection molding die, size permitting. However, an inclined surface inclined inward from the opposite surface D11b (D12b) on which the prism 72 is formed to the light emitting surface D11a (D11a) is required as the inclined surface X with a reflection function. Therefore, manufacture is possible if an inclined surface is formed on the mold, but a large light guide plate on which a prism is disposed cannot be manufactured in an injection molding mold.

Furthermore, in forming the reflective film 22, with a light guide plate manufactured by injection molding, it is necessary to expose only the portion where the reflection function is to be added by masking or the like. This increases the number of steps. Other problems that may be encountered are that the film is vapor deposited in a place where the reflection function is not required due to inaccurate masking of the inclined surface, or conversely, that the film is not vapor deposited in a part of the place where the reflection function is required.

In this embodiment, we will describe a method for manufacturing a light guide plate having an end surface formed on an inclined surface X with a reflection function, which can solve this problem.

First, the step of providing the prism 72 to the light guide plate by nanoimprinting will be described with reference to FIG. 14. FIG. 14 is a diagram illustrating the step of providing the prism 72 to the light guide plate by nanoimprinting.

As shown in FIG. 14, a base material 73 of the light guide plate that is formed flat on both sides is pressed against a mold 70, on which an inverted pattern of the prism 72 has been formed, with a UV curing resin 71 sandwiched in between. Next, the UV curing resin 71 is cured by being irradiating with UV light, after which the base material 73 is removed from the mold 70 (parting). As a result, a prism 72 made of a UV curing resin 71 is formed on one surface (first surface) of the base material 73. Subsequently, a laminate (protective sheet) 75 is affixed to both sides of the base material 73 on which the prism 72 was formed (the surface on which the prism 72 is provided (first surface) and the surface on the opposite side, which serves as the light emitting surface (second surface)). This completes the mother plate 76 of the light guide plate D. The mother plate 76 is subjected to a secondary step in a state in which the laminate 75 is affixed to both sides. Since the light guide plate D would be ruined if scratched, both sides of the mother plate 76 are always laminated.

The mother plate 76 to which the laminate is affixed on both sides is cut into a specific shape (outer shape) in a cutting step (a secondary step), which produces individual light guide plates D. After that, a reflective film 22 is formed on the required end surface.

Next, the step of cutting out the light guide plates D and the step of forming the reflective film 22 will be described with reference to FIG. 15. FIG. 15 is a diagram illustrating the step of cutting out the light guide plates D and the step of forming the reflective film 22, and includes a detail view.

As shown in FIG. 15, the mother plate 76 to which the laminate 75 is affixed on both sides is cut into a specific shape in the cutting step. Here, an end surface having an inclination is formed along with a normal end surface formed at a right angle. The angle of the blade of the cutting device used in the cutting step, or the angle of the stage that supports the mother plate 76, is adjusted so that a specific end surface will become an inclined surface having a specific inclination angle. This allows an inclined surface to be formed simultaneously with the cutting.

After this, in the film formation step, the reflective film 22 is formed on the required end surface of the light guide plate D. Here, the laminates 75 covering both sides of the light guide plate D are used as a mask. That is, the laminates 75 are used as a mask to form the reflective film 22 on the end surface having a specific inclination angle, which was cut out in the cutting step. The laminates 75 are also used as a mask in forming the reflective film 22 on the end surface that was cut out at a right angle. The film can be formed, for example, by vapor deposition, in which a reflective material is vapor deposited.

Thus using the laminates 75 as a mask eliminates the need for going to the trouble of masking, and reduces the number of steps, so that the cost is kept lower. Also, since the end portions of the laminates 75 are cut out together with the light guide plates D, there is an accurate match with the cut-out end surface, and there is none of the later misalignment that can occur with masking. As a result, there are no problems with inaccurate masking of the inclined surface, and it is possible to solve problems such as when vapor deposition is performed in places where the reflection function is not required, or conversely, when vapor deposition is partially missing in places where the reflection function is required, so quality is more stable.

When a step of manufacturing the light guide plates D in this way is included in the method for manufacturing a light emitting device, a light emitting device that is inexpensive and affords excellent space efficiency, despite having a plurality of light emitting surfaces with different angles, can be manufactured in fewer steps and with stable quality.

### SUMMARY

The method for manufacturing a light emitting device according to one mode of the present disclosure comprises a light source unit and a plurality of light guide plates in which light that is incident from an end and is guided through the interior is reflected by a prism and is emitted from a light emitting surface, wherein the plurality of light guide plates are disposed in a row in a state in which the angles of the light emitting surfaces differ between adjacent light guide plates, and the ends of adjacent light guide plates are butted against each other, the light source unit is disposed at the end of a starting end light guide plate that is at one end of the plurality of light guide plates, on the opposite side from the side where the adjacent light guide plates are butted against each other, and the end surface of one of the ends that are butted against each other in the plurality of light guide plates is formed as an inclined surface with a reflection function that changes the angle at which the light is guided and causes the light to be incident on the adjacent light guide plate, wherein the step of manufacturing a light guide plate whose end surface is formed as an inclined surface with a reflection function includes a cutting step of cutting so that a specific end surface becomes an inclined surface having a specific inclination angle between a first surface and a second surface when a light guide plate is cut out into a specific shape from a mother plate in which the first surface, on which a prism is provided by nanoimprinting, and the second surface, which becomes a light emitting surface on the opposite side from the first surface, are covered with a protective sheet; and a film formation step of using the protective sheet covering the first surface and the second surface as a mask to form a reflective film on the end surface having a specific inclination angle that was cut out in the cutting step.

In the above-mentioned light emitting device, a plurality of light guide plates are disposed in a row in a state in which the end portions are butted against each other in a state in which the angles of the light emitting surfaces are different. The end surface of one of the ends that are butted together in the plurality of light guide plates is formed as an inclined surface with a reflection function. The inclined surface with a reflection function has the function of changing the angle of the light that is guided so that the light will be incident on the adjacent light guide plate, and the light can be passed on to the adjacent light guide plate.

Consequently, it is possible to illuminate (light) a plurality of light guide plates that are disposed in a row and constitute light emitting surfaces with different angles, with a shared light source unit. This affords better space efficiency of the light emitting device as compared with a conventional configuration in which a light source unit is required for each of a plurality of light guide plates constituting light emitting surfaces with different angles. Also, sharing a light source unit reduces the number of light source units needed, so costs are lower.

With the above manufacturing method, an inclined surface with a reflection function can be provided even with a light guide plate whose size and shape preclude manufacture in a mold. Also, since an inclined surface can be formed at the same time as cutting in the cutting step, fewer steps are required as compared to when an inclined surface is formed in a separate step.

Moreover, in the film formation step of forming a reflective film on the required end surface, a protective sheet covering the mother plate is used as a mask so as not to cause any damage. This eliminates the need for masking, further reduces the number of steps, and keeps costs lower. Since the end portion of the protective sheet is cut out together with the light guide plate, there is an accurate match with the cut-out end surface, and there is none of the later misalignment that can occur with masking. As a result, there are no problems with inaccurate masking of the inclined surface, and it is possible to solve problems such as when vapor deposition is performed in places where the reflection function is not required, or conversely, when vapor deposition is partially missing in places where the reflection function is required, so quality is more stable.

In the method for manufacturing a light emitting device according to one mode of the present disclosure, the film formation step can be configured such that a reflective film is formed by the vapor deposition of a reflective material. This allows a reflective film to be easily formed.

The method for manufacturing a light guide plate according to one mode of the present disclosure is a method for manufacturing a light guide plate whose end surface is formed as an inclined surface with a reflection function, the method including a cutting step of cutting so that a specific end surface becomes an inclined surface having a specific inclination angle between a first surface and a second surface when a light guide plate is cut out into a specific shape from a mother plate in which the first surface, on which a prism is provided by nanoimprinting, and the second surface, which becomes a light emitting surface on the opposite side from the first surface, are covered with a protective sheet, and a film formation step of using the protective sheet covering the first surface and the second surface as a mask to form a reflective film on the end surface having a specific inclination angle that was cut out in the cutting step.

As discussed above, this makes it possible to manufacture a light guide plate in which an end surface is formed as an inclined surface with a reflection function, in a small number of steps and with stable quality. Consequently, it is possible to favorably manufacture the above-mentioned light emitting device that is inexpensive and affords excellent space efficiency, despite having a plurality of light emitting surfaces with different angles.

In the method for manufacturing a light guide plate according to one mode of the present disclosure, the film formation step can also be configured to form a reflective film by the vapor deposition of a reflective material. This makes it easy to form a reflective film.

The present invention is not limited to the embodiments given above, and various modifications are possible within the scope of the claims. Embodiments obtained by appropriately combining the technical means disclosed in the different embodiments are also encompassed by the technical scope of the present invention.

### REFERENCE SIGNS LIST

2R right side portion (light emitting device)
11 cases
12 LED board
13 board cover
14 inner cover
15 outer cover
20 LED
22 reflective film
30 light emitting device
50 game machine
51 housing
71 UV curing resin
72 prism
75 laminate (protective sheet)
76 mother plate
D1 side light guide plate (light guide plate, first light guide plate, starting end light guide plate)
D2 front light guide plate (light guide plate, second light guide plate, final end light guide plate)
D3 front light guide plate (light guide plate, first light guide plate, starting end light guide plate)
D4 side light guide plate (light guide plate, second light guide plate, final end light guide plate)
D5 front light guide plate (light guide plate)
D6 side light guide plate (light guide plate)
D7 front light guide plate (light guide plate, final end light guide plate)
D10 light guide plate (starting end light guide plate)
D11 light guide plate
D12 light guide plate (final end light guide plate)
D1a to D7a, D10a to D12a light emitting surfaces
D1b to D7b, D10b to D12b opposite surfaces
X inclined surface with reflection function

1. A method for manufacturing a light emitting device, comprising a light source unit; and a plurality of light guide plates in which light that is incident from an end and is guided through an interior is reflected by a prism and is emitted from a light emitting surface, wherein the plurality of light guide plates are disposed in a row in a state in which the angles of the light emitting surfaces differ between adjacent light guide plates, and ends of adjacent light guide plates are butted against each other, the light source unit is disposed at an end of a starting end light guide plate that is at one end of the plurality of light guide plates, on an opposite side from a side where the adjacent light guide plates are butted against each other, and an end surface of one of ends that are butted against each other in the plurality of light guide plates is formed on an inclined surface with a reflection function configured to change an angle at which the light is guided and cause the light to be incident on the adjacent light guide plate.
wherein a step of manufacturing a light guide plate whose end surface is formed on the inclined surface with the reflection function includes:
a cutting step of cutting so that a specific end surface becomes an inclined surface having a specific inclination angle between a first surface and a second surface when a light guide plate is cut out into a specific shape from a mother plate in which the first surface, on which a prism is provided by nanoimprinting, and the second surface, which becomes a light emitting surface on an opposite side from the first surface, are covered with a protective sheet; and
a film formation step of using the protective sheet covering the first surface and the second surface as a mask to form a reflective film on the end surface having a specific inclination angle that was cut out in the cutting step.

2. The method for manufacturing a light emitting device according to claim 1, wherein
the film formation step involves forming a reflective film by a vapor deposition of a reflective material.

3. A method for manufacturing a light guide plate whose end surface is formed on an inclined surface with a reflection function, the method comprising:
a cutting step of cutting so that a specific end surface becomes an inclined surface having a specific inclination angle between a first surface and a second surface when a light guide plate is cut out into a specific shape from a mother plate in which the first surface, on which a prism is provided by nanoimprinting, and the second surface, which becomes a light emitting surface on an opposite side from the first surface, are covered with a protective sheet; and
a film formation step of using the protective sheet covering the first surface and the second surface as a mask to form a reflective film on the end surface having a specific inclination angle that was cut out in the cutting step.

4. The method for manufacturing a light guide plate according to claim 3, wherein
the film formation step involves forming a reflective film by a vapor deposition of a reflective material.
